(19) United States
(12) Patent Application Publication
(10) Pub. No.: US 2023/0116856 A1
(43) Pub. Date: Apr. 13, 2023

(54) Method for Compensating for a Temperature-Induced Rise in Pressure in an Anode Section of a Fuel-Cell System

(71) Applicant: Bayerische Motoren Werke Aktiengesellschaft, Muenchen (DE)

(72) Inventor: Andreas PELGER, Ismaning (DE)

(21) Appl. No.: 17/914,266

(22) PCT Filed: Mar. 11, 2021
(86) PCT No.: PCT/EP2021/056142

§ 371 Date: Sep. 23, 2022

(30) Foreign Application Priority Data
Mar. 25, 2020 (DE) 10 2020 108 177.4

(51) Int. Cl. H01M 8/04082; H01M 8/04746

(52) U.S. Cl. CPC H01M 8/04201; H01M 8/04753; H01M 2200/20; H01M 2250/20

(57) ABSTRACT

A method for at least partially compensating for a temperature-induced rise in pressure in a fuel-cell system includes providing a fuel-cell system that has an anode supply path that establishes a fluidic connection between a fuel-cell stack and at least one fuel-source, and an anode-side stack shut-off valve in the anode supply path, the anode-side stack shut-off valve prohibiting the supply of fuel to the fuel-cell stack from an anode section of the anode supply path. The fuel-cell system also has an excess-pressure valve in the anode section, the excess-pressure valve conducting fuel away out of the anode section if the pressure in the anode section exceeds a tripping pressure. In the shut-down state, the pressure in the anode section rises due to warming of the fuel. The anode-side stack shut-off valve is opened to relieve the pressure before the rising pressure in the anode section reaches the tripping pressure.

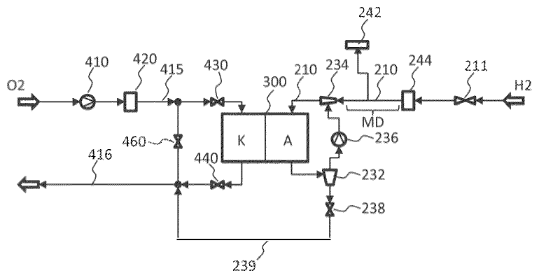

### CROSS REFERENCE TO RELATED APPLICATION

This application is a 371 of International Application No. PCT/EP2021/056142, filed Mar. 11, 2021 which claims priority under 35 U.S.C. § 119 from German Patent Application No. 10 2020 108 177.4, filed Mar. 25, 2020, the entire disclosure of which is herein expressly incorporated by reference.

### BACKGROUND AND SUMMARY OF THE INVENTION

Fuel-cell-powered motor vehicles are known as such. They include a fuel-cell system with an anode subsystem in which, as a rule, a pressure-regulator is provided which isolates a high-pressure region from a medium-pressure region. The medium-pressure region is, in turn, isolated from the anode of the fuel-cell stack via stack shut-off valves. After the motor vehicle has been parked, the case might arise that the pressure in the medium-pressure region rises so intensely that the fuel confined in the medium-pressure region escapes via a safety valve which then trips. Such a discharge of fuel is undesirable.

It is a preferred object of the technology disclosed herein to lessen or to eliminate at least one disadvantage of a previously known solution, or to propose an alternative solution. In particular, it is a preferred object of the technology disclosed herein to avoid a temperature-induced discharge of fuel during parking, without this having a severely negative impact on other parameters such as production costs, weight or space requirement of the anode subsystem. Other preferred objects may arise out of the advantageous effects of the technology disclosed herein. The object(s) is/are achieved by the subject-matter of claim 1. The dependent claims represent preferred embodiments.

The technology disclosed herein relates to a method for at least partially compensating for a temperature-induced rise in pressure in a fuel-cell system, in particular of a motor vehicle. An anode supply path connects a fuel-cell stack to at least one fuel-source. An anode-side stack shut-off valve is provided in the anode supply path. The anode-side stack shut-off valve has been set up to prohibit the supply of fuel to the fuel-cell stack from an anode section of the anode supply path. An excess-pressure valve is provided in the anode section. The excess-pressure valve has been set up to conduct fuel away out of the anode section if the pressure in the anode section exceeds a tripping pressure. In the shut-down state of the fuel-cell system, the pressure in the anode section rises by reason of a warming of the fuel. The method includes the step according to which, in the shut-down state of the fuel-cell system, in particular during the rise in pressure in the anode section, the anode-side stack shut-off valve is opened for the purpose of pressure relief of the anode section even before the pressure in the anode section, which is rising by reason of the fuel warming up, reaches the tripping pressure of the excess-pressure valve, so that a removal of fuel from the anode subsystem is avoidable. Opening may, for instance, be undertaken in time-based or pressure-based manner.

The technology disclosed herein relates to a fuel-cell system with at least one fuel cell. The fuel-cell system is intended, for instance, for mobile applications such as motor vehicles (for example, passenger cars, motorcycles, utility vehicles), in particular for providing the energy for at least one prime mover for propelling the motor vehicle. In its simplest form, a fuel cell is an electrochemical energy-converter which converts fuel and oxidant into reaction products and thereby produces electricity and heat. The fuel cell includes an anode and a cathode which are separated by an ion-selective or ion-permeable separator. The anode is supplied with fuel. Preferred fuels are: hydrogen, low-molecular-weight alcohol, biofuels, or liquefied natural gas. The cathode is supplied with oxidant. Preferred oxidants are, for instance, air, oxygen and peroxides. The ion-selective separator may take the form of a proton-exchange membrane (PEM), for instance. A cation-selective polymer-electrolyte membrane is preferably employed. Materials for such a membrane are, for instance: Nafion®, Flemion® and Aciplex®.

A fuel-cell system includes, in addition to the at least one fuel cell, peripheral system components which may be employed in the course of operation of the at least one fuel cell. As a rule, several fuel cells have been combined to form a fuel-cell stack.

The anode subsystem is formed by the fuel-conducting components of the fuel-cell system. An anode subsystem may exhibit at least one fuel-source (as a rule, a pressurized container), at least one tank shut-off valve, at least one pressure-reducer, at least one anode supply path leading to the anode inlet of the fuel-cell stack, an anode chamber in the fuel-cell stack, at least one recirculation path leading away from the anode outlet of the fuel-cell stack, at least one water-separator, at least one anode-scavenging valve, at least one active or passive fuel-recirculation conveyor, as well as further elements. The main task of the anode subsystem is the feeding and distribution of fuel to the electrochemically active surfaces of the anode chamber, and the removal of anode waste gas.

The fuel-cell system includes a cathode subsystem. The cathode subsystem is formed from the oxidant-conducting components. A cathode subsystem may exhibit at least one oxidant conveyor, at least one cathode inflow path leading to the cathode inlet, at least one cathode waste-gas path leading away from the cathode outlet, a cathode chamber in the fuel-cell stack, as well as further elements.

The anode supply path establishes the fluidic connection between the at least one fuel-source and the anode of the fuel-cell stack. The anode supply path may be formed by several anode supply pipes or by a system of supply pipes which connect the various components in the anode supply path to one another.

The anode supply path may include a pressure-reducer which is connected upstream to the fuel-source, and the anode section may be provided downstream of the pressure-reducer. The pressure-reducer has been designed to reduce the fuel inlet pressure that is applied at the inlet of the pressure-reducer to a fuel outlet pressure or downstream pressure that is applied at the outlet of the pressure-reducer. In the simplest form, it may be a question of a choke. As a rule, the pressure-reducer includes a pressure-reducing valve which, despite differing inlet pressures, ensures that a certain outlet pressure is not exceeded on the outlet side. In the pressure-reducer the fuel expands. The closing pressure of the pressure-reducer, also called lock-up pressure, is the pressure from which the pressure-reducer interrupts the fluidic connection between the inlet and the outlet of the pressure-reducer.

The anode section disclosed herein is, in particular, the section downstream of the pressure-reducer and upstream of the stack shut-off valve, and is also designated as the medium-pressure region of the anode subsystem.

The at least one anode-side stack shut-off valve is a valve device that can seal off the fuel-cell stack with respect to the remaining components of the anode subsystem in gas-tight manner (except for leakage currents). In particular, the anode-side stack shut-off valve isolates the fuel-cell stack from other sections of the anode supply path. Stack shut-off valves serve to prohibit the penetration of fuel, except for leakage currents, into the anode chamber of the fuel-cell stack, which is substantially sealed off by the stack shut-off valves, in a phase where the motor vehicle is not being used. For instance, a proportional valve or injector may form the stack shut-off valve. Such a valve may advantageously serve at the same time as a further pressure-reducer and/or as a metering valve.

The excess-pressure valve is arranged in the anode section or medium-pressure region and eases the load on the anode section if the pressure in the anode section reaches or exceeds the tripping pressure of the excess-pressure valve. The excess-pressure valve is preferably a mechanical valve which can be opened and closed again. The tripping pressure of the excess-pressure valve is greater than the closing pressure of the pressure-reducer, for example about 10% to about 20% greater than the closing pressure. In particular, the excess-pressure valve has been designed in such a way that the excess-pressure valve trips, as a rule, before an excessive pressure might damage the components of the anode section.

The fuel-source may be a pressurized container, in particular a cryogenic pressurized container or a high-pressure gas container. High-pressure gas containers are designed to store fuel permanently at ambient temperatures at a nominal working pressure (NWP) of at least 350 bar gauge pressure (=excess pressure in relation to atmospheric pressure) or at least 700 bar gauge pressure. A cryogenic pressurized container is suitable to store the fuel at the aforementioned working pressures even at temperatures that lie distinctly (for example, more than 50 kelvins or more than 100 kelvins) below the minimum working temperature of the motor vehicle.

The shutting down of the fuel-cell system is also designated as shutdown or coasting down. Shutting down encompasses all the steps that bring the fuel-cell system into a state in which it can remain in the parked state of the motor vehicle. Shortly before or at the beginning of the phase in which the motor vehicle is in the parked state, the fuel-cell system is shut down. According to the technology disclosed herein, the motor vehicle is in the parked state or in the “parking” state if the user of the vehicle has left the motor vehicle. As a rule, in the parked state the motor vehicle assumes a state in which it consumes minimal electrical energy, in order to realize maximum standing-times. In this state, therefore, expediently only functions are available that serve to put the motor vehicle back into an operational state (in particular, central locking, evaluating key fob) and to guarantee a safe parking of the motor vehicle (for example, parking light, parking brake, anti-theft alarm system, etc.). In addition to these functions, further autarchic functions may be capable of being switched on in the parked state. The control unit of the fuel-cell system has been switched off in the “parking” state and, as a rule, is switched on only when the motor vehicle is to be brought back into the ready-to-drive state or when at least one autarchic function is to be carried out. The “parking” state may obtain, in particular, when the vehicle has been secured via the central locking system and when no activity of a user of the vehicle has been perceptible in the vehicle for a certain time, so the user of the vehicle is presumably not in the vehicle.

In the shut-down state of the fuel-cell system, as a rule the pressure in the anode section rises by reason of the warming of the fuel. At the time at which the fuel-cell system assumed the shut-down state, the pressure in the anode section corresponds substantially to the closing pressure of the pressure-reducer.

If at least one pressurized container is employed as fuel-storage device, the fuel cools down greatly during withdrawal by reason of its expansion in the anode supply path. At the same time, the motor vehicle may be exposed to high ambient temperatures, particularly in summer in many countries, so that a large temperature difference arises, in particular downstream of the pressure-reducer, between the fuel located in the anode section and the immediate vicinity of the anode section. The temperature in the immediate vicinity of the warming anode section may also be designated as the installation-space temperature. The installation-space temperature is influenced by the outside temperature in the vicinity of the motor vehicle and by the waste heat from other components such as, for instance, the fuel-cell stack, the power electronics, etc. This temperature difference has the effect that the fuel in the anode section warms up considerably. Since the fuel is confined in the anode section, the pressure in the anode section gradually rises.

The technology disclosed herein includes the step according to which, in particular during the rise in pressure in the anode supply path, the anode-side stack shut-off valve is opened for the purpose of pressure relief of the anode section even before the rising pressure in the section reaches the tripping pressure of the excess-pressure valve. Downstream of the anode-side stack shut-off valve the pressure is lower than in the anode section. Consequently, after the anode-side stack shut-off valve has been opened the warmed fuel flows into the anode chamber of the fuel-cell stack, as a result of which the pressure in the anode section decreases markedly. Advantageously, the situation is consequently avoided where fuel is let out into the environment via the excess-pressure valve which then trips for the purpose of component protection. Excess-pressure valves with a lower tripping pressure may also be employed. Overall, the components of the anode section may be designed for lower maximum pressures. As a rule, this has a positive impact on the production costs, the weight and the space requirement.

The anode-side stack shut-off valve can be opened for the purpose of pressure relief only for a short time, for instance less than 1 minute, 10 seconds, or less than 1 second, or less than 100 milliseconds. This has the advantage that the valves are open only for as long as is necessary for the purpose of pressure relief, and otherwise the individual fuel-conducting regions of the anode subsystem are separated from one another. If several shut-off valves have been provided, also only one stack shut-off valve can be opened. The opening-time may vary, in particular depending on the technology being used (for example, proportional valve, injector, etc.).

Expediently, the anode-side stack shut-off valve is only opened for the purpose of pressure relief after a defined first period of time has elapsed from the time starting from which the fuel-cell system assumed the shut-down state. This may have been provided in order that the pressure in the anode section can firstly also rise markedly by reason of the warming fuel. In one embodiment, there may be provision that several pressure-relief operations are undertaken during the warming of the fuel. The period of time between the first pressure relief and the second pressure relief is the second period of time. The second period of time is longer than the first period of time. This is advantageous, because after the first pressure relief the pressure in the anode section will rise more slowly, and generally the stack shut-off valve should be opened as seldom as possible. The first period of time and/or the second period of time may amount to between 3 minutes and 20 minutes or between 5 minutes and 10 minutes.

The first period of time and/or the second period of time may be defined on the basis of an ambient-temperature value that is directly or indirectly indicative of the temperature in the immediate vicinity of the warming anode section. The ambient-temperature value is accordingly indicative of the installation-space temperature. For instance, the outside temperature in the case of the motor vehicle can be determined in the motor vehicle (by measuring or registering a corresponding item of information from a server), and a corresponding installation-space temperature may have been assigned to this outside temperature. The correlation between installation-space temperature and ambient temperature can be determined, for instance, by simulations and/or by series of experiments.

The first period of time and/or the second period of time may be defined on the basis of a fuel-temperature value that is directly or indirectly indicative of the fuel temperature in the anode section. In one embodiment, the fuel-temperature value can be registered by a temperature sensor in the anode section. In another embodiment, the fuel temperature in the pressurized container is registered, and the temperature in the anode section is approximated with the aid of the registered fuel temperature in the pressurized container. The correlation between the temperatures in the pressurized container and the temperatures in the anode section can be determined by experiments and/or simulations.

The first period of time and/or the second period of time may be defined by a characteristic map saved in the fuel-cell system. The characteristic map may have been saved, for instance, in a non-volatile memory of the control unit. Various values for the period of time may have been saved in the characteristic map, each of which depends on the ambient-temperature value, the fuel-temperature value and an initial-pressure value that is directly or indirectly indicative of an initial pressure in the anode section at the time at which the fuel-cell system assumed the shut-down state. In one embodiment, the pressure in the anode section can be measured. In another embodiment, the pressure can be registered at a different place on the anode supply path, and the initial pressure in the anode section can be approximated from this value. Instead of an acquisition of pressure, the density could also be determined, which would likewise be indicative of the initial pressure by reason of the invariable volume in the anode section. Accordingly, different periods of time can be defined on the basis of the characteristic map for different initial pressures, ambient temperatures and fuel temperatures. It can consequently be ensured that only a few pressure-relief operations are carried out. Consequently, the anode-side stack shut-off valve is closed as often as possible or for as long as possible, and the control unit of the fuel-cell system has to be activated as seldom as possible during parking, having a positive impact on the energy consumption during parking.

In one embodiment, there may be provision that the first period of time, the second period of time, the fuel-temperature value, the ambient-temperature value and/or the initial pressure value is/are determined during the shutting down of the fuel-cell system, that the control unit of the fuel-cell system is inactive during the first period of time and/or the second period of time, and that the control unit of the fuel-cell system is activated for the purpose of pressure relief. For this purpose, a timer in a higher-ranking controller may be employed, which reactivates the control unit of the fuel-cell system.

In a further embodiment, the method may comprise the following steps:
registering a pressure value that is indicative of the current pressure in the anode section (MD) during the warming of the fuel in the shut-down state of the fuel-cell system; and
opening the anode-side stack shut-off valve if the registered pressure value in the anode section exceeds a limiting value.

In a further embodiment, there may accordingly be provision that the control unit of the fuel-cell system remains active until the fuel in the anode section has warmed up to such an extent that, with sufficient probability, no pressure relief is any longer necessary. In particular, there may be provision that the control unit registers the pressure in the anode section directly or indirectly. For this purpose, a pressure sensor may, for instance, have been provided in the anode section. The anode-side stack shut-off valve can be opened if the registered pressure in the anode section exceeds a limiting value. The limiting value has been chosen in such a way that the anode section is depressurized before the pressure in the anode section reaches the tripping pressure of the excess-pressure valve.

The method disclosed herein may provide the step that the anode-side stack shut-off valve, which was opened for the purpose of pressure relief, is closed again before a closing pressure of the pressure-reducer is reached. Advantageously, the method disclosed herein has been configured in such a way that (i) the pressure relief begins at a pressure in the anode section that lies (preferably just) below the tripping pressure of the excess-pressure valve, and that (ii) the pressure relief ends at a pressure in the anode section that lies (preferably just) above the closing pressure of the pressure-reducer. It can consequently be ensured that, on the one hand, no fuel escapes unnecessarily from the anode subsystem and, on the other hand, fuel which may be possibly needed at a later time—as a rule, after several hours—for an autarchic function of the motor vehicle is not supplied to the anode chamber of the fuel-cell stack at too early a time. Consequently the fuel supply in the anode supply path can be used advantageously for the autarchic function, without a tank shut-off valve having to be opened in the parked state of the motor vehicle.

The control unit may, amongst other things, have been set up to carry out, or to carry out jointly, the method steps disclosed herein. For this purpose, the control unit can, at least partially and preferably completely, regulate (closed-loop) or control (open-loop) the actuators of the system on the basis of signals provided. The control unit can influence at least the fuel-cell system, in particular the cathode subsystem, the anode subsystem and/or the cooling system of the fuel-cell system. Alternatively or additionally, the control unit may also have been integrated within another control unit, for example within a higher-ranking control unit. The control unit can interact with other control units of the motor vehicle.

Furthermore, the technology disclosed herein relates to a computer-readable storage medium on which program instructions are stored which, when executed by a microprocessor, cause the latter to execute a method according to one of the preceding claims.

In other words, the technology disclosed herein relates to a method for pressure relief of the medium-pressure region. After the halting of withdrawal (that is to say, the fuel-cell stack is off), the idea now is to open the anode-side stack shut-off valve (as a rule, a hydrogen shut-off valve) or the injectors once again briefly after a certain time, in order to lower the pressure that has built up in the medium-pressure pipe, since the confined gas has warmed up within a volume, and in the process to increase the anode pressure slightly. There is sufficient volume in the anode to cause an increase in pressure of merely a few mbar and at the same time to reduce the pressure in the medium-pressure region, for example to the closing value (lock-up pressure) of the pressure-reducer. A still further reduction of the medium pressure is not necessary, but would not be disadvantageous either. If the pressure were to fall to a value below the closing value, hydrogen would continue to flow out of the high-pressure region of the pipes—that is to say, upstream of the pressure-regulator. The actuating of the medium-pressure withdrawal system (as a rule, a proportional valve or an injector) may be undertaken in time-based manner, for example after 5 minutes to 7 minutes, and may, when required, be repeated once more, for example after a further 10 minutes to 15 minutes (the interval becomes longer, since the density has decreased and the temperature difference between the fuel in the pipes and the installation-space temperature has become smaller).

Alternatively, a characteristic curve or a characteristic map can be ascertained which can be calculated as a function of the density of the fuel and the temperature difference, in order to determine the time for the withdrawal from the medium-pressure pipe, and the quantity to be withdrawn.

With the technology disclosed herein, a pressure-relief valve with a lower tripping pressure can be provided, without a temperature-induced removal of fuel from the anode subsystem occurring. Consequently, a more favorable and lighter safety valve can be employed. Advantageously, the other components of the medium-pressure region may also be designed for a low bursting pressure, which may have a positive impact on the production costs, the space requirement and the weight. According to one embodiment, there may be provision that after the parking of the motor vehicle the fuel-cell system continues to be operated for a predetermined time with tank shut-off valves closed, in order that the pressure in the anode inflow path is reduced further. However, such a shutdown procedure is not always possible, particularly if another protective function has brought about an unforeseen stoppage of the fuel-cell system (for example, emergency stop).

With the technology disclosed herein, it is possible to provide fuel increasingly for autarchic operation (for example, fuel for pressurizing the anode when parking), without opening the tank valves (also called on-tank valves) of the pressurized containers, since the pipes do not have to be depressurized in the course of parking.

### BRIEF DESCRIPTION OF THE DRAWING

The FIGURE shows a schematic view of a fuel-cell system according to at least one embodiment.

### DETAILED DESCRIPTION OF THE DRAWING

Fuel—for example, hydrogen at up to 700 bar—is stored in the pressurized container H2. The pressurized container H2 provides hydrogen for the fuel-cell stack 300 which exhibits a plurality of fuel cells which are operated at a lower pressure level, for example 0.5 bar to 1 bar gauge pressure. A tank shut-off valve 211 is provided at one end of the pressurized container H2. Instead of just one pressurized container H2 with one tank shut-off valve 211, several pressurized containers H2 with one or more tank shut-off valves 211 might also have been provided. The fuel-conducting fluidic connection between the pressurized container H2 and the fuel-cell stack 300 supplies the anode A of the fuel-cell stack 300 with fuel and is designated as the anode supply path 210. In the system represented here, a pressure-reducer 244 is further provided. The pressure-reducer 244 lowers the storage pressure from up to 700 bar to a medium-pressure level of, for instance, 2 bar to 40 bar, or 12 bar to 18 bar. In the anode supply path 210 an anode-side stack shut-off valve 234 is further provided, which here acts as a further pressure-reducer and lowers the pressure from the medium-pressure level to the low pressure of the fuel cells. Here, the anode section MD is the section of the anode supply path 210 that is provided downstream of the pressure-reducer 244 and upstream of the anode-side stack cut-off valve 234. This anode section MD may also be designated as the medium-pressure region.

In order to prevent bursting of the pipelines or damage to components (screw couplings, sensors, anode shut-off valve, etc.) of the anode supply path 210 in the event of malfunction of the pressure-reducer 244, an excess-pressure valve 242 is provided here downstream of the pressure-reducer 244. Here, a water-separator 232, an anode-scavenging valve 238 and a recirculation pump 236 are provided in the recirculation flow path 216 of the anode subsystem downstream of the fuel-cell stack 300. The anode-scavenging pipe 239 here connects the anode-scavenging valve 238 to the cathode waste-gas pipe 416 which begins downstream of the cathode K of the fuel-cell stack and ends in the environment. A catalytic-converter surface (not shown) may have been provided in this waste-gas pipe 416. In a further embodiment, the anode-scavenging pipe 239 leads upstream of the cathode K into the cathode supply pipe 415, in particular downstream of the cathode-side stack shut-off valve 430. The directions of flow of the fuel and of the ambient air are represented here by arrows. The fuel-cell system has been integrated into a motor vehicle (not shown). The oxidant conveyor 410 compresses the oxidant O2 which is subsequently cooled in the heat-exchanger 420. Furthermore, a bypass pipe 460 is provided which branches off from the cathode supply pipe 415 and leads into the waste-gas pipe 416.

If fuel is now withdrawn, it expands and thereby cools down. If the fuel-cell system is now shut down, fuel that is cold relative to the installation-space temperature remains in the anode section MD. By reason of the large difference between the fuel temperature and the ambient temperature, heat is introduced into the fuel, as a result of which the fuel in the anode section MD warms up and the pressure in the anode section MD rises. Unless corrective measures are taken, the pressure might exceed the tripping pressure of the excess-pressure valve 242. Consequently, fuel would then be let out into the environment via the excess-pressure valve 242. According to the technology disclosed herein, this is prevented by the inactive control unit being reactivated, in order to initiate a pressure relief into the anode chamber of the fuel-cell stack 300 after the first period of time has elapsed. The pressure relief is achieved by a brief opening of the stack shut-off valve 234. After the pressure relief, the pressure in the anode section MD has fallen markedly. In particular, the anode-side stack shut-off valve 234 is opened here until such time as the pressure substantially corresponds to the closing pressure of the pressure-reducer. If the pressure in the anode section MD continues to rise due to the temperature, after a second period of time has elapsed a second pressure relief and, where appropriate, further pressure-relief operations can be initiated. Preferably, the control unit is inactive between the pressure-relief operations and the stack shut-off valve 234 is closed.

The foregoing description of the present invention serves only for illustrative purposes and not for the purpose of restricting the invention. Various amendments and modifications are possible within the scope of the invention without departing from the scope of the invention and its equivalents.

1-15. (canceled)

16. A method for at least partially compensating for a temperature-induced rise in pressure in a fuel-cell system, comprising:
providing a fuel-cell system, including:
an anode supply path that establishes a fluidic connection between a fuel-cell stack and at least one fuel-source,
an anode-side stack shut-off valve in the anode supply path, wherein the anode-side stack shut-off valve is configured to prohibit the supply of fuel to the fuel-cell stack from an anode section of the anode supply path, and
an excess-pressure valve in the anode section, wherein the excess-pressure valve is configured to conduct fuel away out of the anode section if the pressure in the anode section exceeds a tripping pressure,
wherein, in the shut-down state of the fuel-cell system, the pressure in the anode section rises by reason of a warming of the fuel; and
opening the anode-side stack shut-off valve so as to relieve the pressure before the rising pressure in the anode section reaches the tripping pressure of the excess-pressure valve.

17. The method of claim 16, wherein the stack shut-off valve is open for the purpose of pressure relief for less than 10 seconds or less than 1 second or less than 100 milliseconds.

18. The method of claim 16, wherein the stack shut-off valve is opened for the purpose of pressure relief after a defined first period of time has elapsed from the time starting from which the fuel-cell system assumed the shut-down state.

19. The method of claim 16, wherein several pressure-relief operations are undertaken during the warming of the fuel.

20. The method of claim 19, wherein the period of time between a first pressure relief and a second pressure relief is a second period of time, and wherein the second period of time is longer than the first period of time.

21. The method of claim 20, wherein the first period of time and/or the second period of time amount(s) to between 3 minutes and 20 minutes or between 5 minutes and 10 minutes.

22. The method of claim 20, wherein the first period of time and/or the second period of time is/are defined on the basis of an ambient-temperature value that is indicative of the temperature in the immediate vicinity of the warming anode section.

23. The method of claim 20, wherein the first period of time and/or the second period of time is/are defined on the basis of a fuel-temperature value that is indicative of the fuel temperature in the anode section (MD).

24. The method of claim 20,
wherein the first period of time and/or the second period of time is/are defined by a characteristic map saved in the fuel-cell system, and
wherein various values for the period of time are stored in the characteristic map, each of which depends on: (a) an ambient-temperature value, (b) a fuel-temperature value, and/or (c) an initial pressure value that is indicative of an initial pressure in the anode section at the time at which the fuel-cell system assumed the shut-down state.

25. The method of claim 24, wherein the first period of time, the second period of time, the fuel-temperature value, the ambient-temperature value and/or the initial pressure value are determined during the shutting down of the fuel-cell system.

26. The method of claim 20, wherein a control unit of the fuel-cell system is inactive during the first period of time and/or the second period of time, and wherein the control unit is activated for the purpose of pressure relief.

27. The method of claim 16, further comprising:
registering a pressure value that is indicative of the current pressure in the anode section during the warming of the fuel in the shut-down state of the fuel-cell system; and
opening the anode-side stack shut-off valve if the registered pressure value in the anode section exceeds a limiting value.

28. The method of claim 16, wherein the anode supply path includes a pressure-reducer which is connected to the fuel-source, and wherein the anode section is provided downstream of the pressure-reducer.

29. The method of claim 16, wherein the anode-side stack shut-off valve is closed again for the purpose of concluding the depressurizing before a closing pressure of the pressure-reducer is reached or when the closing pressure is reached.

30. A non-transitory computer-readable medium on which program instructions are stored which, when executed by a microprocessor, cause the microprocessor to execute the method of claim 16.
